(19) United States
(12) Patent Application Publication
(10) Pub. No.: US 2013/0162491 A1
(43) Pub. Date: Jun. 27, 2013

(54) DUAL RADIATION PATTERNS ANTENNA

(71) Applicant: Ya Chung Yu, Taipei (TW)

(72) Inventor: Ya Chung Yu, Taipei (TW)

(73) Assignee: SJ ANTENNA DESIGN, Taipei City (TW)

(21) Appl. No.: 13/557,191

(22) Filed: Jul. 24, 2012

(30) Foreign Application Priority Data
Dec. 26, 2011 (TW) 100148773

(51) Int. Cl. H01Q 9/04; H01Q 19/30; H01Q 13/10

(52) U.S. Cl. 343/767; 343/700 MS; 343/819

(57) ABSTRACT

A dual radiation patterns antenna is provided in the present invention. The dual radiation patterns antenna includes a substrate, a first antenna unit and a second antenna unit. The substrate has a first surface and a second surface opposite to the first surface. The first antenna is formed on the first surface of the substrate and used to radiate a first radiation pattern. The second antenna is formed on the second surface of the substrate and used to radiate a second radiation pattern. A first vertical projecting plane of the first antenna unit on the second surface is overlapped with the second antenna unit completely or partially. A second vertical projecting plane of the second antenna unit on the first surface is overlapped with the first antenna unit completely or partially. The first radiation pattern and the second radiation pattern are perpendicular each other.

### CROSS-REFERENCE TO RELATED APPLICATION(S)

This application claims the priority benefit of Taiwan patent application No. 100148773, filed on Dec. 26, 2011. The entirety of the above-mentioned patent application is hereby incorporated by reference herein and made a part of this specification.

### FIELD OF THE INVENTION

The present invention relates to an antenna, and more particular to a dual radiation patterns antenna.

### BACKGROUND OF THE INVENTION

Due to the rapid development on wireless transmission systems, many new products must have the performance of wireless transmission so as to meet the consumer's requirement. Antenna is an important element for transmitting and receiving electromagnetic wave energy in the wireless transmission system. The wireless transmission system can not transmit and receive data without the antenna. Thus, the antenna is an indispensable element related to a whole performance of the wireless communication system.

Generally, the antennas are grouped into isotropic antennas, omni-directional antennas and directive antennas according to directivities thereof. Wherein, the directive antenna can transmit and receive electromagnetic energy of a specific direction, so that it can be widely used in fixed direction-based wireless communication systems. In addition, considerations have to be taken when the antenna is designed according to different frequency bands used in different countries. The commonly used specifications of frequency bands include IEEE 802.11, the most popular bluetooth communication (IEEE 802.15.1), and the like. The bluetooth works at a frequency band of 2.4 GHz. IEEE 802.11 is further divided into 802.11a, 802.11b and 802.11g, wherein the 802.11a specification corresponds to a frequency band of 5 GHz, and the 802.11b and 802.11g specifications correspond to a frequency band of 2.4 GHz. A high speed transmission application for high definition digital video operating at a frequency of 60 GHz and transmitting data at a rate of 20 Gbit/sec is considered to be an indispensable transmission module in the future mobile telecommunication and adopted in the specification of 802.11ad.

Since the signal in 60 GHz tends to be absorbed by oxygen in atmosphere, the signal is merely transmitted in a short distance (e.g. smaller than 10 m). Therefore, the radiation pattern and the efficiency in the wireless communication system are very important that may affect the data transmission rate and the application environment. In order to broaden the operating range and overcome the signal decayed in atmosphere, the antenna needs to have an endfired radiation pattern and a broadside radiation pattern simultaneously for a portable wireless application environment, especially for a smart mobile phone or a tablet personal computer.

A bi-directional radiation antenna or device generally utilizes two antenna units, for example, two patch antennas or slot antennas to execute the bi-directional radiation. According to a conventional method, the patch antenna and the slot antenna are arranged on the same plane. It is not only complexity, cost and the size of the antenna are increased, but also a high directivity can not be achieved (for example, due to an inadequate system grounding area of the patch antenna). Oppositely, the area occupied by the antennas can be decreased while stacking the patch antenna on the slot antenna or stacking the slot antenna on the patch antenna, but the radiation efficiency will be decreased due to the signal coupling interference between the radiation patterns of the slot antenna and the patch antenna.

For overcoming the mentioned disadvantage of prior art above, a novel dual radiation patterns antenna is provided in the present invention.

### SUMMARY OF THIS INVENTION

The main aspect of the present invention is to provide a dual radiation patterns antenna through which a signal would be received and transmitted from both sides of the dual radiation patterns antenna, so that the range of signal receiving and transmitting angle covered by the dual radiation patterns antenna would be broadened. Besides, the efficiency and directive of the wireless transmission system would be improved and the size thereof would be miniatured.

In accordance with the aspect of the present invention, the dual radiation patterns antenna includes a substrate, a first antenna unit and a second antenna unit. The substrate has a first surface and a second surface opposite to the first surface. The first antenna is formed on the first surface of the substrate and used to radiate a first radiation pattern. The second antenna is formed on the second surface of the substrate and used to radiate a second radiation pattern. A first vertical projecting plane of the first antenna unit on the second surface is overlapped with the second antenna unit completely or partially. A second vertical projecting plane of the second antenna unit on the first surface is overlapped with the first antenna unit completely or partially. The first radiation pattern and the second radiation pattern are perpendicular each other.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a cross-section view schematically illustrating a dual radiation patterns antenna according to a first preferred embodiment of the present invention;

FIGS. 2A and 2B are cross-section views schematically illustrating the dual radiation patterns antenna according to a second preferred embodiment of the present invention; and

FIGS. 3A and 3B are cross-section views schematically illustrating the dual radiation patterns antenna according to a third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only, it is not intended to be exhaustive or to be limited to the precise form disclosed.

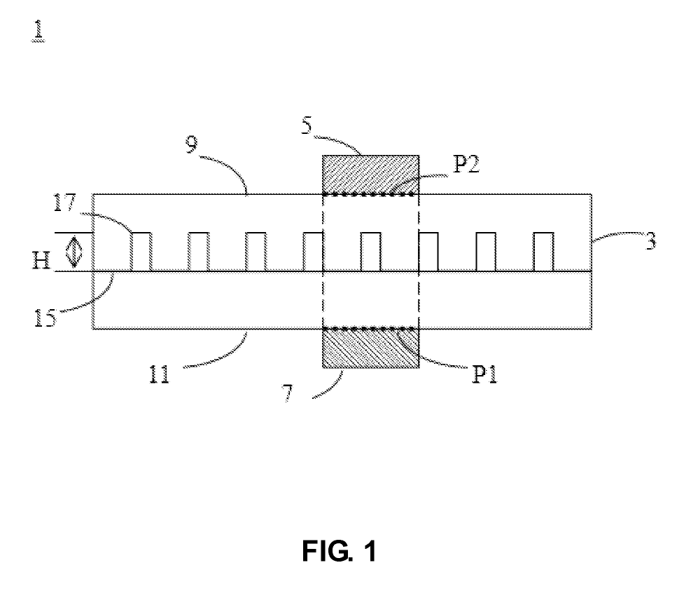

Please refer to FIG. 1, which schematically shows a cross-section view of the dual radiation patterns antenna according to a first preferred embodiment of the present invention. As shown in FIG. 1, the dual radiation patterns antenna 1 includes a substrate 3, a first antenna unit 5 and a second antenna unit 7. The substrate 3 has a first surface 9 and a second surface 11 opposite to the first surface 9. The substrate 3 is a printed circuit board or a stacked circuit board. The first antenna 5 and the second antenna 7 are formed on the first surface 9 and the second surface 11 of the substrate 3, respectively. A first vertical projecting plane P1 of the first antenna unit 5 on the second surface 11 is overlapped with the second antenna unit 7 completely. A second vertical projecting plane P2 of the second antenna unit 7 on the first surface 9 is overlapped with the first antenna unit 5 completely.

The substrate 3 of FIG. 1 further includes a community ground plane 15 which is disposed between the first surface 9 and the second surface 11. The first antenna unit 5 is a tapered slot antenna or a yagi antenna and a center frequency band thereof is equal to or larger than 60 GHz. The first antenna unit 5 is used to radiate a first radiation pattern (not shown) which is parallel to the substrate 3. The first radiation pattern is endfired radiation pattern. The second antenna unit 7 is a patch antenna and a center frequency band thereof is equal to or larger than 60 GHz. The second antenna unit 7 is used to radiate a second radiation pattern (not shown) which is perpendicular to the substrate 3. The second radiation pattern is broadside radiation pattern. Consequently, the first radiation pattern and the second radiation pattern are perpendicular each other.

According to FIG. 1, the substrate 3 further includes a plurality of via holes 17 which are formed between the first surface 9 and the community ground plane 15 to isolate the first antenna unit 5 and the community ground plane 15, so as to decrease the influence of the community ground plane 15 on the first radiation pattern of the first antenna unit 5. A depth H of each via hole 17 is equal to an odd multiple of one-quarter effective wavelength. For the first antenna unit 5, the via holes 17 and the community ground plane 15 would be combined as an artificial magnetic conductor (AMC). For the second antenna unit 7, the community ground plane 15 would be a perfect electric conductor (PEC) and merely has the grounding function while the via holes 17 are neglected. Thus, the utilization of substrate 3 would be improved and the signal coupling interference between the endfired radiation pattern and the broadside radiation pattern would be depressed due to the first antenna unit 5 and the second antenna unit 7 are disposed on the first surface 9 and the second surface 11 opposite to the first surface 9 of the substrate 3, respectively.

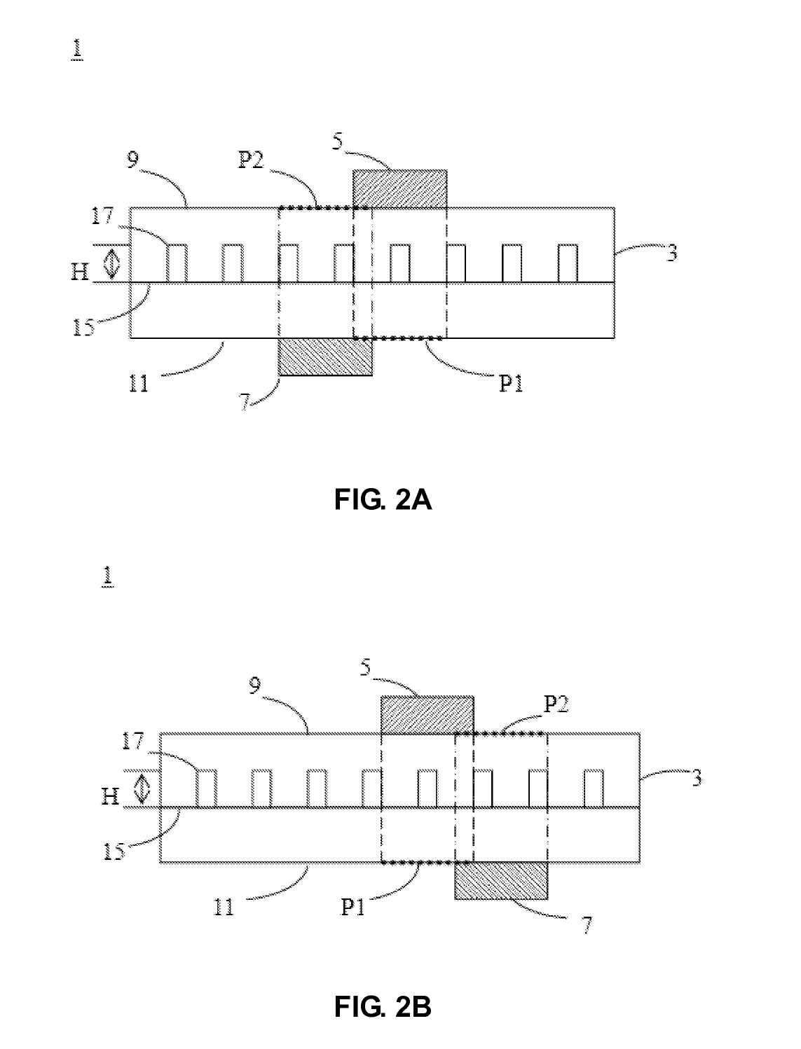

Please refer to FIGS. 2A and 2B, which schematically show cross-section views of the dual radiation patterns antenna according to a second preferred embodiment of the present invention. The symbols used in FIGS. 2A and 2B are same as FIG. 1. As shown in FIGS. 2A and 2B, the first vertical projecting plane P1 of the first antenna unit 5 on the second surface 11 is overlapped with the second antenna unit 7 partially. The second vertical projecting plane P2 of the second antenna unit 7 on the first surface 9 is overlapped with the first antenna unit 5 partially.

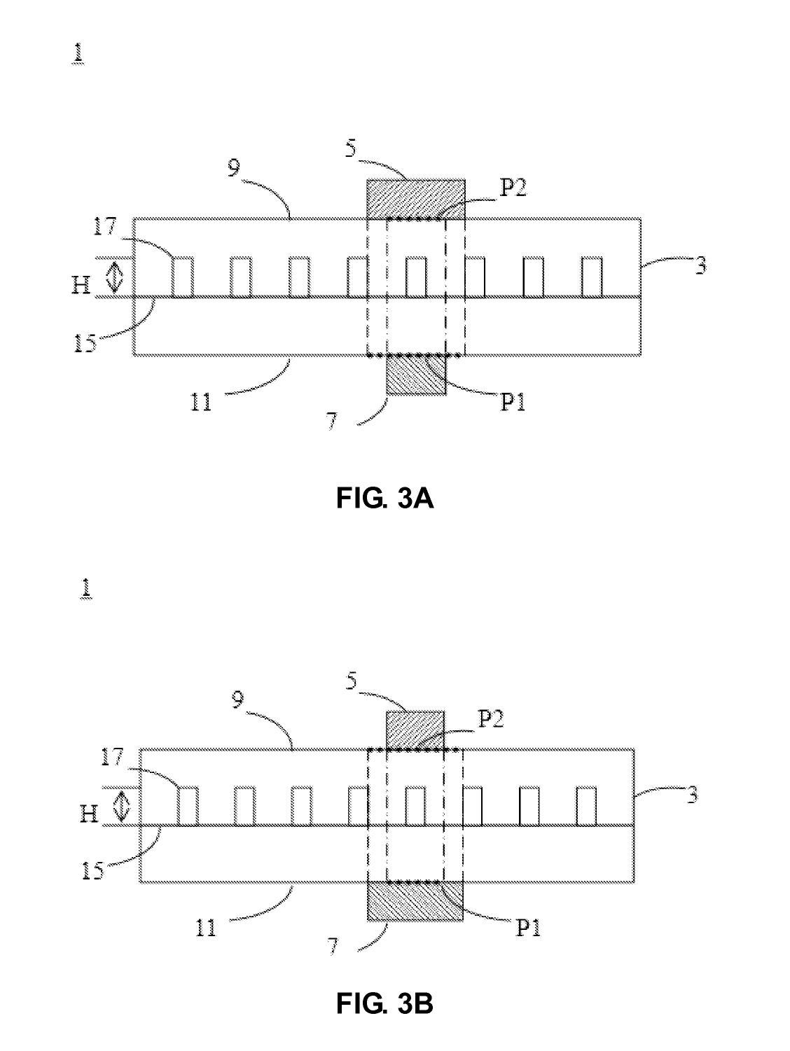

Please refer to FIGS. 3A and 3B, which schematically show cross-section views of the dual radiation patterns antenna according to a third preferred embodiment of the present invention. The symbols used in FIGS. 2A and 2B are same as FIG. 1. As shown in FIGS. 3A and 3B, the first vertical projecting plane P1 of the first antenna unit 5 on the second surface 11 is overlapped with the second antenna unit 7 partially. The second vertical projecting plane P2 of the second antenna unit 7 on the first surface 9 is overlapped with the first antenna unit 5 partially.

As the above, a dual radiation patterns antenna is provided in the present invention. The first vertical projecting plane of the first antenna unit on the second surface is overlapped with the second antenna unit completely or partially. The second vertical projecting plane of the second antenna unit on the first surface is overlapped with the first antenna unit completely or partially. Thus, the utilization of the substrate in the dual radiation patterns antenna would be improved and the size of the wireless transmission system therewith would be miniaturized to meet the miniaturization trend of the current electrical device. In addition, the range of signal receiving and radiating angle covered by the dual radiation patterns antenna would be broadened and the efficiency and directive of the wireless transmission system would be improved due to the first radiation pattern is perpendicular to the second radiation pattern. Furthermore, the signal coupling interference between the endfired radiation pattern and the broadside radiation pattern would be depressed due to the first antenna unit and the second antenna unit being disposed on the first surface and the second surface opposite to the first surface of the substrate, respectively. Accordingly, the present invention would be applied to a high definition digital video with high speed transmission and the center frequency band thereof is equal to or larger than 60 GHz.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A dual radiation patterns antenna, comprising:
a substrate having a first surface and a second surface opposite to the first surface;
a first antenna unit forming on the first surface of the substrate and used to radiate a first radiation pattern; and
a second antenna unit forming on the second surface of the substrate and used to radiate a second radiation pattern;
wherein a first vertical projecting plane of the first antenna unit on the second surface is overlapped with the second antenna unit completely or partially, a second vertical projecting plane of the second antenna unit on the first surface is overlapped with the first antenna unit completely or partially and the first radiation pattern and the second radiation pattern are perpendicular each other.

2. The dual radiation patterns antenna as claimed in claim 1, wherein the substrate is a printed circuit board or a stacked circuit board.

3. The dual radiation patterns antenna as claimed in claim 1, wherein the substrate further comprises a community ground plane disposed between the first surface and the second surface.

4. The dual radiation patterns antenna as claimed in claim 3, wherein the substrate further comprises a plurality of via holes formed between the first surface and the community ground plane.

5. The dual radiation patterns antenna as claimed in claim 4, wherein a depth of each via hole is equal to an odd multiple of one-quarter effective wavelength.

6. The dual radiation patterns antenna as claimed in claim 4, wherein the via holes and the community ground plane are combined as an artificial magnetic conductor.

7. The dual radiation patterns antenna as claimed in claim 1, wherein the first antenna unit is a tapered slot antenna or a yagi antenna.

8. The dual radiation patterns antenna as claimed in claim 1, wherein a center frequency band of the first antenna unit is equal to or larger than 60 GHz.

9. The dual radiation patterns antenna as claimed in claim 1, wherein the first radiation pattern is endfired radiation pattern.

10. The dual radiation patterns antenna as claimed in claim 1, wherein the first radiation pattern is parallel to the substrate.

11. The dual radiation patterns antenna as claimed in claim 1, wherein the second antenna unit is patch antenna.

12. The dual radiation patterns antenna as claimed in claim 1, wherein a center frequency band of the second antenna unit is equal to or larger than 60 GHz.

13. The dual radiation patterns antenna as claimed in claim 1, wherein the second radiation pattern is broadside radiation pattern.

14. The dual radiation patterns antenna as claimed in claim 1, wherein the second radiation pattern is perpendicular to the substrate.
